(19) United States
(12) Patent Application Publication
(10) Pub. No.: US 2014/0186493 A1
(43) Pub. Date: Jul. 3, 2014

(54) Solar Powered Brewing of Beverages

(71) Applicant: Joseph Bair, Trenton, NJ (US)

(72) Inventor: Joseph Bair, Trenton, NJ (US)

(21) Appl. No.: 12/895,508

(22) Filed: Sep. 30, 2010

Related U.S. Application Data
(60) Provisional application No. 61/277,853, filed on Sep. 30, 2009.

(51) Int. Cl. C12C 13/00; C12C 7/04; C12C 11/00

(52) U.S. Cl. 426/16; 426/592; 426/466; 426/600; 99/278

(57) ABSTRACT

There has always been an energy cost to the heating associated with brewing either fermented or unfermented beverages. A novel method brewing is described in an effort to reduce or eliminate this energy cost by using the free and renewable source of energy: solar power. Included in this method is solar energy produced wort, solar roasted grains and roasted hops. Also described is a novel fermentation product, specifically a beer product. Also presented is a system that provides an environmentally sound inexpensive source of heat for wort production, roasting grains and roasting hops. This system creates roasted grains, roasted hops and worts that are different from those created by other known heating methods.

Described is a method of brewing that is a combination of wort production, grain roasting and roasted hops using solar power. Also described, are a wort, a mash, solar roasted grains, roasted hops, the beverages that can be produced from said wort, mash, roasted grains, roasted hops and a kit for conducting solar brewing.

### CROSS REFERENCE TO RELATED APPLICATION

This U.S. non-provisional application claims priority under 35. U.S.C. §119(e) to U.S. Provisional Application Ser. No. 61/277,853 filed on Sep. 30, 2009, the entire contents of which are hereby incorporated by reference.

### FIELD OF INVENTION

In a non-limiting way, the invention described herein generally is in the field of the process of brewing, as well as the field of using solar power as an energy source. The invention is specifically in the field use of a solar powered heat source in the process of making a beverage, particularly a fermented beverage, as well as the use of solar power in the preparation of grains and hops for brewing. The invention is also in the field of worts, grains, mashes, hops, beverages, beers and kits for using solar power.

### BACKGROUND OF THE INVENTION

### Background of Brewing

Brewing is recognized as a traditional and important pursuit of mankind. It is significant to many cultures, both in present times and in the history of the development of human cultures. Brewing has been presented by some anthropologists that the incentive of early cultures to adopt a permanent agriculturally based society in favor of a nomadic hunter-gatherer culture is due to the desire to brew fermented beverages, especially beer (see Diamond, Jared, Nature 419, p 6898, hereby incorporated by reference in its entirety). Through-out history, and especially in modern brewing, all brewing generally requires at least some heat, whether to roast grains, prepare ingredients, or prepare the wort.

The roasting of grains gives styles of beer distinct flavors. Roasting of grains for beer and other brewed beverages is well-known to the knowledgeable brewer. Each method of roasting imparts particular flavors and qualities to the beverage produced from those grains. It is critical to crafting particular styles of beer. Such roasting requires heat. Providing the heat for roasting has a cost in terms of resources, money and environmental effect.

Likewise, the production of wort generally requires heat, also with the aforementioned costs. The process of wort production is well-known to the knowledgeable brewer. The modern production of beer involves the required step of wort production. In very general terms, wort is produced by first making malt from a starch source, traditionally, dried, sprouted barley. Grain adjuncts are then added and the malt is ground into grist. Water is added to malted and unmalted crushed grain such as, to form a slurry or mash. The mash undergoes a complex heating process that enables enzymes to convert the starches and other complex sugars are converted into simpler sugars. The slurry is often called at this stage, “sweet wort.”

Generally, once the sweet wort mixture has been created, it is then boiled, either whole or in part, in order to sanitize as well as extract the flavor and aroma from the hops, which are added to the wort at particular times at the desire of the brewer. At the end of the mashing, the hot wort is cooled to a temperature favorable to the yeast. Once sufficiently cooled, so that yeast can be are added, or pitched, the wort is created and can subsequently be fermented. The wort at this stage is often called the, “hopped wort”.

Hops in brewing mainly adds bitterness and impart a hop flavor (e.g., taste and smell) in the final product. Hops are composed of soft resins, hard resins, hop oils, waxes, lipids, and carbohydrates. The soft resins consist of a acids and β acids. The soft resins and a hop oil fraction are extractable by organic solvents, or by liquid and supercritical CO₂. In conventional brewing, the α-acids are converted into iso-α acids which are responsible for the bitterness taste. However, as the character of hop flavor is concerned, its description in beer is subjected to a great deal of debate, but all agree that the hop flavor in essential part in the wort and subsequently in the beer.

Over the years, the foregoing general process has been tinkered with and altered by brewmasters to produce beers of differing flavors, coloring, clarity, and alcohol content. Differing pressures, temperatures, grains, yeasts, and fermentation times produce differing beers, which is inclusive of ales and lagers (U.S. Pat. No. 7,735,412 to Burdick, hereby incorporated by reference in its entirety).

Heating the wort has always been a required part of wort production and thereby part of brewing. It is speculated that wood fires were the first sources of heat for wort production as well roasting of grains. As mankind cooked with different fires (e.g. dung, charcoal, coal, etc.) it is speculated that he also made wort for his beer with the same fires. In the present time it is well-known to use modern stoves, both gas and electric, for making wort and roasting grains for brewing. However, until now solar power has yet to be described as heat for the purpose of making wort or roasting grain for brewing (See, David Martorana, Philly Brew Scene, Oct. 4, 2009, and Joseph Bair Philly Brew Scene, October 2010, submitted for publication, both articles hereby incorporated by reference in their entireties).

### Background of Solar Power

Like beer, solar power too has an ancient history, combined of both fact and myth. From the time of ancient China concentrated sunlight has been used to perform useful tasks. A Greek legend has it that Archimedes used a “burning glass” to concentrate sunlight on the invading Roman fleet and repel them from Syracuse. In 1973 a Greek scientist, Dr. Ioannis Sakkas, curious about whether Archimedes could really have destroyed the Roman fleet in 212 BC lined up nearly 60 Greek sailors, each holding an oblong mirror tipped to catch the Sun's rays and direct them at a tar-covered plywood silhouette 160 feet away. The ship caught fire after a few minutes; however, historians continue to doubt the reality of the Archimedes story.

Whether or not Archimedes harnessed the power of the sun in ancient times, in modern times the use of solar power has developed in parallel with better optics and other inventions. In 1866, Auguste Mouchout used a parabolic trough to produce steam for the first solar steam engine. In 1886, Alessandro Battaglia obtained the first patent for a Solar Collector in Genoa, Italy. Over the following years, inventors such as John Ericsson and Frank Shuman developed concentrating solar-powered devices for irrigation, refrigeration, and locomotion. In 1913 Shuman finished a 55HP parabolic solar thermal energy station in Meadi, Egypt for irrigation. Giovanni Francia designed and built the first solar concentrated plant which entered in operation in Sant'Ilario, Italy in 1968.

There exists a need for an energy efficient method for brewing using solar energy. Herein is presented the use of solar power for brewing, thereby producing a wort using solar energy, roasting grains using solar energy and roasting hops using solar energy. The solar energy-produced wort alone can be used in a fermentation process to produce a beer or other fermentation products. Likewise, the solar roast grains can be used in combination with the solar energy-produced wort and/or the roasted hops and/or independently in the brewing process. Similarly the roasted hops can be used in combination with the solar energy-produced wort and/or the solar roasted grains and/or independently in the brewing process. Although beer making and solar power both have ancient histories the combination has never been described hereto date. The results of the effort to combined solar power and wort production is useful, efficient, and unexpected, producing a fermented beverage distinct from other previously described fermented beverages.

### BRIEF SUMMARY OF THE INVENTION

The invention is method of brewing using solar power as an energy source. Specifically, the invention is making a wort wherein the mash has been assembled in a container, the container having a top surface, at least one side surface, and a bottom surface, the container also having an outside and an inside; wherein, energy, especially energy from solar photons concentrated by a Fresnel lens, is directed to the outside side surface of the container producing heat that is conducted through the material of the container to the mash therein such that the heat from the photons is substantially the source of heat of the wort making. The invention is also the fermented beverage, especially beer, which is made from the wort as described.

The invention is also the method making a wort including a grain and a hops, wherein, the grains are roasted prior to being added to the mash; and/or the hops are roasted, prior to being added to the wort. Additionally, the invention is a kit containing instructions on how to prepare a wort using solar power as a hear source.

The invention is further a method of roasting grains using solar power as a source of heat, wherein solar energy is directed to assembled grains and applied to the grains in a manner and duration to produce a desired roast. The invention is especially directed to the roasting of malted barley. The invention is also the grains that result from such solar powered roasting, as well as the beverages that are prepared from the solar roasted grains. Additionally, the invention is a kit containing instructions on how to solar roast grains.

The invention is still further a method of roasting hops for use in brewing, wherein heat is applied to the hops prior to use of said hops in a brewing method, especially when solar power is used as a source of the heat. The invention is also the hops that result from such solar powered roasting. The invention is also the beverages that are prepared from the roasted hops. Additionally, the invention is a kit containing instructions on how to roast hops.

Additionally the invention is a kit for conducting fermentation, wherein the kit includes: (i) A lens; and (ii) Instructions for use of the lens for directing solar energy in the process of wort making; and/or (iii) a Fresnel lens; and/or (iv) wherein yeast is provided; and/or (v) wherein grains are provided; and/or (vi) wherein hops are provided.

### BRIEF DESCRIPTION OF THE FIGURES

FIG. 1 depicts the positioning of the solar brewing apparatus wherein a Fresnel lens is used to concentrate the solar energy and a glazed insulated enclosure is used to retain the heat energy within the system after the energy has been converted from solar energy.

FIG. 2 depicts a solar brewing apparatus where the glazing of the insulated enclosure and a mirrored backstop allows for efficient capture of solar energy without having to track the suns movement over time.

### DETAILED DESCRIPTION OF THE INVENTION

### Terms

By the term “mash”, as used herein, it is meant, at the minimum, the assembly of, water and a complex sugar source and any nutrients needed to needed to support a strain of yeast.

By the term “wort”, as used herein, it is meant, at the minimum, mash that has been heated to convert the complex sugars in the mash to a sugar capable of supporting a strain of yeast.

By the term “wort-making”, as used herein, it is meant, at the minimum, the process of heating mash to convert a sugar of a into a simpler form.

By the term “fermentation”, as used herein, it is meant, at the minimum, the process of introducing a yeast strain to a wort that capable of supporting said yeast strain in terms of nutrients, including sugars, pressure and temperature.

By the phrase “photons of solar energy”, as used herein, it is meant the elemental unit energy that emanates from the sun and pass through the earth's atmosphere which carries energy in the form of electromagnetic energy.

By the phrase “Fresnel lens”, as used herein, it is meant a lens that reduces the amount of material required compared to a conventional spherical lens by breaking the lens into a set of, at least two, concentric annular sections, or parallel linear sections known as “Fresnel zones”.

By the term “caramelized”, as used herein, it is meant, at the minimum, the use of heat and amino acids to convert complex sugar, including starches into other sugars and other chemicals. As used herein “caramelized” and “caramelization” refers to a pyrolysis reaction and the amino-acid assisted Maillard reaction.

By the term “roasting”, as used herein, it is meant, at the minimum, applying a dry heat, to an ingredient usually causes caramelization or Maillard browning of the surface of the ingredient. The terms, “roasting” and “toasting”, are used interchangeably herein, all intended to mean “roasting”. Other forms of these words such as roast, toast, roasted and toasted, all intended have equivalent meanings comparable to the meaning of “roasting” as stated above.

By the term “yeast”, as used herein, it is meant any yeast. This includes, Saccharomyces cerevisiae, Schizosaccharomyces pombe, sake yeasts, wine yeasts, Koji yeasts and shochu yeasts. The terms “Saccharomyces cerevisiae” and “brewer's yeast” are used interchangeable and both refer specifically to the species Saccharomyces cerevisiae.

By the abbreviation “atm”, as used herein, it is meant, “atmosphere” the standard unit of measure for pressure.

By the abbreviation “F”, as used herein, it is meant, “Fahrenheit” the standard unit of measure for temperature.

By the abbreviation “C”, as used herein, it is meant, “Celsius” the standard unit of measure for temperature.

By the abbreviation “IBU”, as used herein, it is meant, “International Bitterness unit” a measure of bitterness frequently used in determine hops utilization during brewing.

By the abbreviation “BTU”, as used herein, it is meant, “British Thermal Unit” a unit of measure for heat.

By the abbreviation “DMS”, as used herein, it is meant, “dimethyl sulfides”.

By the abbreviation “LME”, as used herein, it is meant, “Liquid malt extract” an ingredient used in wort production and brewing.

By the abbreviation “DME”, as used herein, it is meant, “Dried malt extract” an ingredient used in wort production and brewing.

### An Overview of the Invention

The invention is the combination of solar power with the method of brewing. Experienced brewers will recognize that the invention can be used with almost any known form of brewing, including homebrewing methods. In general, the invention using solar energy as the major source of heat for the heating steps involved in brewing. Such steps are producing wort from mash, including boiling the wort, as well as any boiling for sterilization purposes, and for roasting the grain. Also, presented here is the novel approach to flavoring by using heat to roast hop, especially the use of solar-energy as the energy source for this roasting.

In general terms, brewing as conducted with the invention starts with formulation of a mash. Any mash formulation can be used with the invention, including all grain mashes and malt extract mashes. It is recognized that the mash can be composed of almost any type of sugar or starch including but not limited to barley, especially, malted barley, wheat, corn (maize), rye, rice, spelt, millet, milo maize, oats, buckwheat, sorghum, quinoa, honey, tapioca, cassava, manioc, triticale, tef, dinkel, amaranth and combinations thereof.

In mash formulated with grain, if desired, the grains can be roasted to produce particular types of flavors and brewing styles. In general, the malting process germinates the raw grain and right before the seed is broken by the growing endosperm of starch inside the seed (acrospire), when the starch grows 75-100% of the area inside the seed, it is called fully modified (germinated) and the process is stopped by applying heat (kilned) at various temperatures and moisture contents, producing various colors, sweetnesses, toastiness and other favors. The present invention can be used to the heat source for this kilning of the new malt also. In the simplest use of the invention, solar-energy is directed to the starch using a lens, preferably a Frensel lens, until the desire temperature is reach and sustained for the desired duration. In a more preferred form of the invention, an oven with glazing is used to permit the solar energy to enter the oven through the glazing, strike the starch and heat the starch, while the oven reduces the dissipation of the heat energy.

The mash is assembled with water and with a selection of starches and/or sugars. Other ingredients may be added to the mash depending on the desire of the knowledgeable brewer and the flavors desired to be induced in the wort and ultimately in the beverage produced there from. The mash is placed in a container. The mash is placed on the inside of the container so that the mash is in contact with the inside surface of the container. It is helpful for the efficient practice of the invention if the outside side surface of the container is a dark color, preferably a shade of black or a shade of dark green. It is also helpful to the practice of the invention if a thermometer is used to measure the outside surface temperature of container to infer the temperature of the mash contained therein. It is most preferable to use a thermometer to directly measure the temperature of the mash inside the container.

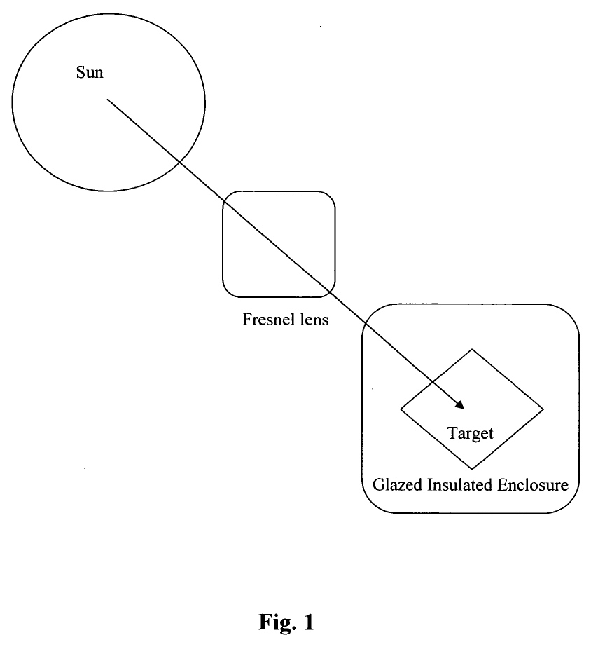

In the practice of the invention wort is produced from the mash by heating at a temperature and duration according to the desire of the knowledge brewer and the desire to produce a particular taste or style of beverage from the resulting wort. In the practice of the invention, the heating step or steps are preformed by directing solar energy to the outside side surface of the container holding the mash using a lens (See FIG. 1). The solar energy directed to the outside side surface of the container, heats outside surface, the material of the container conducts the heat to the inside surface and to the mash contained therein. Any method of making wort can be used with the invention. The three most preferred methods of wort production are the infusion method, the step (or temperature controlled) method and the decoction method. In the infusion method the wort is produced from mash raised to a single temperature for a duration of time. Practitioners of the infusion method of wort production are aware to use modified malt so that the desired nutrients are released into the wort after reaching the target temperature for the target duration of time. In the step (or temperature controlled) method, the starches, grains and sugars are raised to several specific temperatures each for a particular duration of time to convert the starches and sugars and release nutrients, as well as to impart a particular flavor and/or create a particular style of wort for a particular flavor or style of beverage to be produced from the wort. Modified malts are not required for conducting the step method of wort production. The decoction method is similar to the step method in which multiple target temperatures reached each for particular duration of time. However, the temperatures are achieved by removing a portion of the mash bringing it to boil and returning the portion to the mash, thus raising the temperature of the mash. Such a method can be conducted using solar power; however, the solar energy is directed through a lens to the outside-side surface of the container holding the removed portion of the mash until such time as the solar energy causes the mash in the container to boil (See FIG. 1).

Generally, hops are added during the production of the wort. Hops can be added at anytime during the brewing process. Knowledgeable brewers recognize that the time the hops is added during the brewing process has as much influence on the flavor the hops provide to the beverage, as does the quantity and type of hops added. Hops are often referred to based on time at which they are introduced to the brewing process. For instance, “bittering hops” are added during the production of the wort, at the beginning of the boiling the wort; “aroma hops” are added to the wort during the last minutes of the boiling step; the term “dry hopping” refers to hops that are added when the fermenting wort is in the secondary fermenter, if used, or after cooling the wort and adding yeast but least a few days before bottling or kegging.

During the course of the invention it was recognized that solar energy could be applied to the hops, so that the hops roast. Roasted hops, the solar roasted hops in particular, impart a special flavor to the worts in which they are used. This special flavor can be tasted in the beverages produced from the wort. Roasted hops, preferably solar roasted hops can be used at any time during the brewing process, i.e., roasted hops are suitable for use as any style of hops including but not limited to the aforementioned bittering hops, aroma hops, and/or in dry hopping.

After the wort has been held at the desired temperature or temperatures for the desired duration or durations of time, it is generally common to boil the wort. The invention can be used for the boiling step of brewing, if such a step is practiced. The same heating method is used to boil the wort as was used to heat the wort. Solar energy is applied through a lens, preferably through a Fresnel lens, to the outside side-surface of the container, so that the material of the container conducts the heat from the solar energy striking the container to the inside-side surface of the container and from there to the wort contained within the container. In the boiling step solar-energy is applied to the outside side-surface of the container for a duration of time until boiling occurs. The knowledgeable brewer continues to apply heat to boil the wort for the desired duration of boiling time inconsideration of the desired product and use. The energy can be applied, removed or redirected as needed to prevent boil over or any other undesirable consequence of heating.

After the wort is produced it is cooled to a particular temperature that is suitable for adding yeast if the wort is desired to be fermented. If fermentation is not desired for the production of a beverage or product, the knowledge brewer should take other steps as desired to formulated the desired beverage or other product from the wort. If a fermented beverage, especially beer, is desired when the wort is cooled to a temperature that will not kill the strain of yeast to be used in the fermentation step. When the wort is cooled to the desired temperature the yeast can be added (or pitched) to the wort. Any method of fermentation can be used with the invention. Furthermore, any suitable yeast can be used in the fermentation step of the invention. Generally after a few days of fermentation, the fermenting wort is transferred (or racked) to a secondary fermenter for a period of time before bottling or kegging, accordingly to the desires of the brewer. Some brewers prefer to add other ingredients during the cooling, fermentation or secondary fermentation steps. All of these practices can be used in accord with the present invention.

The invention includes the beverages or other products that are produced from solar-power heated wort, and/or solar roasted grains and/or solar roasted hops. The products that have been produced from these methods are recognized as being distinctly different from products that were produced prior to the invention, (See, David Martorana, Philly Brew Scene, Oct. 4, 2009 and Joseph Bair Philly Brew Scene, October 2010, submitted for publication).

### Wort

Wort can be produced using present invention from any mash. Mashes can be made from water containing complex sugars and enzymes. Any source of complex sugar can be used with the present invention. Starches are the preferred source of complex sugars. Barley, especially, malted barley is the most preferred starch. However, wheat, corn (maize), rye, rice, spelt, millet, milo maize, oats, buckwheat, sorghum, quinoa, honey, tapioca, cassava, manioc, triticale, tef, dinkel, amaranth and combinations thereof are also preferred. It is recognized that it may be desirable to use a single source of starch or sugar; however, it is preferred if combination of starches and/or sugars are used. Frequently, such combinations are different roasts, or malts, or ummalted grains. Often the starches are prepared from different species. It is conceivable that the starches of the mash could be modified or synthesized in a lab.

The mash is placed into a container. The container has an inside and an outside. The container also has a bottom surface and at least one side surface and optionally a top surface (i.e. a lid). It is conceived that the side surface and/or the bottom surface and/or the top surface could be the same surface, (i.e. a half sphere, a sphere, or some other spheroid). Containers with a top surface are referred to as closed containers and containers without a top surface are referred to as open containers. It is preferable to use the invention with a closed container, it is also preferable if the closed container has a vent or valve for letting heat and gas out of the system. In one preferred form of the invention the container can be safely pressured by the heating so that the pressure inside the container is more that standard atmospheric pressure. In a more preferred form of the invention, the pressure inside the container is allowed to rise to 15 psi above atmospheric pressure (2.02 atm); in an even more preferred form of the invention the pressure inside the container is allowed to rise to 30 psi above atmospheric pressure (3.04 atm); in a still more preferred form of the invention the pressure inside the container is allowed to rise to 500 psi (34 atm); in yet more preferred form of the invention the pressure inside the container is allowed to rise to 1000 psi (68 atm); in still more preferred form of the invention the pressure inside the container is allowed to rise to 1500 psi (102 atm); in a most preferred form of the invention the pressure inside the container is allowed to rise to 3000 psi (204 atm). The container can be made of any material that can withstand the heating temperature and serve as a conducted material to transfer heat energy from the outside side surface of the container to the inside side surface of the container and then to the mach contained within. It is preferable that the container is made out of a metal or metal alloy. It is more preferable that the container is made out of aluminum, steel, or copper. It is preferable that the outside side surface of the container is a dark color. It is more preferable that the outside side surface of the container is a dark green or black. The mash is placed on the inside of the container so that the mash is in contact with the inside surface of the container.

Traditional wort making has previously used conventional methods of heating or cooking. Wort making generally uses a heat source at the bottom surface of a container to raise the temperature of the wort. While the heat sources typically vary from common sources such as wood or coal fire, combusting propane or natural gas, electric heat source or the like, the surface of the application of heat remains the same: the bottom of the container. Furthermore, due the tendency of the solids of the wort to accumulate at the bottom surface of the inside of the container the temperatures at the point of contact with the container are kept to being only a little greater than boiling temperature of water so as to prevent burning of the wort solids.

Due to desire to use solar power as a heating source, the present invention was configured to heat the container holding the mash from the side surface rather than from the bottom surface. The results of fermentation of a wort produced with a side surface source of energy for heating from a traditional mash and fermented using traditional methods unexpectedly produced a remarkably different tasting beer (See, David Martorana, Philly Brew Scene, Oct. 4, 2009 and Joseph Bair Philly Brew Scene, October 2010, submitted for publication).

### Mash

The primary type of mash ingredient is grain that has been malted. Modern-day recipes generally consist of a large percentage of a light malt and, optionally, smaller percentages of more flavorful or highly-colored types of malt. The former is called “base malt”; the latter is known as “specialty malts”. However, any collection of mash ingredients, or “grain bill” can be used with the present invention. It is recognized that the selection of mash ingredients, the starch or starches selected, the color of the malt, the treatment of the grain and other factors contribute to the composition of the wort and the taste of the fermented beverages produced for the wort.

Generally, the grain used for making wort is milled prior to use. Milling increases the surface area of the grain, making the starch more accessible, and separates the seed from the husk. Care ought to be taken when milling to ensure that the starch reserves are sufficiently milled without damaging the husk and providing coarse enough grits that a good filter bed can be formed during lautering. Enzymes release from cells in the grains and carried into the mash from the milling process, are generally thought to be active during wort production. Any method of mill can be used with the present invention. It is recognized that the type of milling conducted, the courseness of the grain, the uniformity or lack thereof, the duration of the milling and other factors contribute to the composition of the wort and the taste of the fermented beverages produced for the wort.

The mash is the collection of those materials used as the starting ingredients for producing a wort, and generally, later for fermenting into alcohol. The act of creating and extracting fermentable and non-fermentable sugars and flavor components from grain begins by steeping it in hot water, and then allowing it to rest at specific temperature ranges in order to activate enzymes that will convert the starches to sugars. The sugars will later be converted to alcohol and other fermentation products by yeast in the brewing process.

### Decoction

Decoction during wort production is where a proportion of the grains are removed from the mash, boiled and then returned to the mash, raising the temperature. The boiling extracts more starch from the grain by breaking down the cell walls of the grain. It can be classified into one-, two-, and three-step decoctions, depending on how many times part of the mash is drawn off to be boiled. It is a traditional method, and is common in German and Central European breweries. Decoction was initially used out of necessity before the invention of thermometers allowed simpler step mashing. But the practice continues for many traditional beers because of the unique malty flavor it lends to the beer; boiling part of the grain results in Maillard reactions leading to malty flavors.

In decoction, part of the mash is taken out of the container and placed in a cooker, where it is boiled for a period of time. This caramelizes some of the sugars, giving the beer a deeper flavor and color, and frees more starches from the grain, making for a more efficient extraction from the grains. The portion drawn off for decoction is calculated so that the next rest temperature is reached by simply putting the boiled portion back into the mash tun. Before drawing off for decoction, the mash is allowed to settle a bit, and the thicker part is typically taken out for decoction, as the enzymes have dissolved in the liquid, and the starches to be freed are in the grains, not the liquid. This thick mash is then boiled for around 15 minutes, and returned to the mash tun. The invention can be used with the decoction method to provide heat with solar energy during the boiling steps.

The mash cooker used in decoction should not be allowed to scorch the mash, but maintaining a uniform temperature in the mash is not a priority. Traditionally, to prevent a scorching of the grains, the brewer must continuously stir the decoction and apply a slow heating. However, using the invention as described herein, placing the heat source on the side of the container eliminates the need for continuous stirring.

A Decoction mash brings out a higher malt profile from the grains and is typically used in Bocks or Doppelbock style beers.

### Hops

Hops in brewing mainly add bitterness and impart a hop flavor (e.g., taste and smell) in the final product. Hops are composed of soft resins, hard resins, hop oils, waxes, lipids, and carbohydrates. The soft resins consist of a acids and βacids. The soft resins and a hop oil fraction are extractable by organic solvents, or by liquid and supercritical CO₂. In conventional brewing, the α-acids are converted into iso-α acids which are responsible for the bitterness taste. However, as the character of hop flavor is concerned, its description in beer is subjected to a great deal of debate, but all agree that the hop flavor (or the kettle hop flavor) is an essential part in the total organoleptic impact of beer.

When hops, hop extracts, or a hop oil fraction undergo boiling in wort, the hop oils (terpene and sesquiterpene hydrocarbons) are lost mostly through volatilization. As a result, these hydrocarbons are not found in most beers in significant amounts and therefore are not responsible for kettle hop flavor (V. Peacock and M. Deinzer, ACS Symp. Series 170:119-127, 1981). The surviving hop oil components include some oxidized hop oil compounds in very small quantities. We and other investigators have found that these oxidized compounds have very little effect on the kettle hop flavor (J. Irwin, Proc. Cony. Inst. Brew 20:99-104, 1988; Y. Fukuoka and M. Kowaka, Rep. Res. Lab. Kirin Brew. Co. 26:31-36, 1983).

Hops or a hop oil fraction have often been added after fermentation to maintain such volatile hydrocarbon flavors. This practice is called “dry hopping” (J. G. Guzinski, The New Brewer pp. 19-21, July-August 1989; L. Narzi.beta., et al., Monatsschrift fur Brauwissenschaft 38(10):406-409, 1985). But these hop flavors are not considered to be a true and delicate “kettle hop flavor”. In the past, attempts have been made to separate hop oil components into various fractions with the purpose of adding these fractions to unhopped beer in order to achieve kettle hop flavor in the products thus produced.

Hop essential oils, like hop bitter resins, are easily lost during storage due to their susceptibility to oxidation. In storage trials at the U.S.D.A. Hop Research Lab at O.S.U. in Corvallis, Oreg. oil losses were found to range from 28-90% in six months at room temperature depending on the variety. These losses can be slowed by storing hops in the freezer, preferably in a package that allows no air or water exchange (i.e. “barrier”). Brewers have been historically advised to seal, protect and maintain the stability of the hops prior to use in order to maximize the hops essential oils and hop bitter resins. To roast hops, using sunlight or otherwise, is, opposite of the advice of hops and brewing experts (See, The Essential Oil of Hops: Aroma and Flavor in Hops and Beer by Glenn Tinseth, Brewing Techniques' January/February 1994, hereby incorporated by reference in its entirety).

There is a long history of attempts to provide greater stability to hop used in brewing beer. Mitchell, U.S. Pat. Nos. 3,973,092 and 3,973,052, describes a concentrated soft extract, consisting of potassium isohumulate (UTA), and containing 15% to 25% water. This solution is stable, does not separate into two phases on standing, and can be added to water to make a 1% to 2% solution of iso-alpha acids, which is also stable. Westermann, U.S. Pat. No. 3,798,332 describes stable solutions hops extracts of dihydro iso-alpha acids (DHIA). This product, which is light stable, is commercially provided as a 35% solution in water. U.S. Pat. No. 6,242,038 to Guzinski et al. describes a water-dispersible lipidic hop extract composition, comprising at least 10% by weight of free fatty acid substances derived from hops, is useful to increase the utilization of the hop aroma and flavor components. It may be produced by treatment of an extract of hops with an excess of alkali. The extract is suitable for use in the brewing of light-stable beers. U.S. Pat. Nos. 3,973,092 and 3,973,052, to Mitchell, U.S. Pat. No. 3,798,332 to Westermann and U.S. Pat. No. 6,242,038 to Guzinski et al. are all hereby incorporated by reference in their entireties. Traditional hops have been stored and handled in such a way as to preserve the stability of the hops and the chemical compounds contained within the hops. It is counter intuitive to the industry standard for the treatment of hops to add heat to hops.

PCT Publication WO 1997046116, hereby incorporated in its entirety by reference, seems to be an exceptional voice to the conventional belief of protecting hops from heat. However, consistent with conventional theory on stabilizing hops before use, the authors of WO 1997046116 roast hops only after the hops has been utilized in the wort making process. The authors direct their roasting applications to “hop solids” or spent hops. The authors do not suggest roasting of fresh hops.

In the process of experimentation with solar heating, solar rays roasted the hops. Introducing the roasted hops to the wort, even a wort created by traditional heating techniques adds novel compounds to the wort, creating a novel wort, and therefore a novel fermentation product, including novel beer.

### Fermentation

Fermentation in brewing is the conversion of carbohydrates to alcohols and carbon dioxide or organic acids using yeasts, bacteria, or a combination thereof, under anaerobic conditions. A more restricted definition of fermentation is the chemical conversion of sugars into ethanol.

After the wort is cooled and aerated—usually with sterile air—yeast is added to it, and it begins to ferment. It is during this stage that sugars developed from the malt are metabolized into alcohol and carbon dioxide, and the product can be called beer for the first time.

### Yeast

Saccharomyces cerevisiae is the preferred yeast but any yeast for brewing such as a sake yeast, a wine yeast, and a shochu yeast can be employed optionally so that manufacturing beers with a new quality of filling taste and the like that is not obtained by using a brewer's yeast may become possible. Saccharomyces cerevisiae, brewer's yeast, can be used by itself or concomitantly with other yeast for brewing. Also, yeast for brewing other than a brewer's yeast can be used together. Any obtainable yeast including a brewer's yeast can be used suitably and for example, a sake yeast include K-9, K-14, and K-86 of Brewing Society of Japan.

### Solar Power

Due to ever increasing usage of non-renewable energy sources such as fossil fuels, much attention is being directed toward solar energy. Solar energy has been found to be effective in water heating.

Many solar heat collectors are attractive in performance but lack in cost-effectiveness. Many solar heating systems require several years of operation to return the initial investment, turning many citizens away from solar energy as an alternative energy source.

Solar heat collectors are generally divided into two categories depending on how they function to utilize the sunlight.

One category of solar heat collectors utilizes the device of the “green-house effect”. Usually they operate in a stationary position, taking advantage of light-transmitting covers which trap heat energy of longer wavelengths produced by penetrating shorter wavelengths of light which are absorbed by black surfaces situated beneath the covers. In U.S. Pat. No. 3,194,228 to Bargues, hereby incorporated by reference in its entirety, a black corrugated panel with conduits attached is used to absorb solar radiation. Water is circulated through the conduits to collect the heat. Another “green-house effect” type of collector is described in U.S. Pat. No. 4,055,163 to Costello et al. hereby incorporated by reference in its entirety, this collector differs from the Bargues collector in that a black liquid is utilized in lieu of a black corrugated panel to absorb solar radiation. This collector employs a non-focusing reflective surface to remove unwanted heat. The black fluid is circulated through a light-transmitting conduit which is situated above the reflective surface substantially masking the reflective surface from sunlight when in operation. The heated black liquid is circulated through a heat exchanger which transfers heat to water.

The second category of solar collectors are Focusing type solar heat collectors. These solar collectors, obtain high efficiency by concentrating sunlight by means of reflectors or lenses. A large area of sunlight is focused onto a smaller target or conduit. A liquid such as water is circulated through the target or conduit to collect heat by conduction. In U.S. Pat. No. 2,907,318 to Awot, hereby incorporated by reference in its entirety, a corrugated reflected surface is employed as means for focusing sunlight onto conduits positioned in the valleys of the corrugations. This collector employs a light-transmitting cover air spaced over the conduits.

U.S. Pat. No. 4,325,359, hereby incorporated by reference in its entirety, discloses a focusing solar heat collector comprising a light reflective corrugated base surface, a plurality of spaced apart, light-transmitting conduits positioned in the corrugations of the reflective surface so that light reflected by the reflective surface is focused on the conduits, and an organic black liquid of high boiling point circulated through the conduits to receive the focused solar light.

For example, U.S. Pat. No. 4,488,935, hereby incorporated by reference in its entirety, to Ruhe sets forth an apparatus utilizing a microwave energy source and a solar energy collector which may both be used to heat a fluid for distillation.

U.S. Pat. No. 4,495,034 to Lucas, hereby incorporated by reference in its entirety, sets forth a water treatment apparatus including a reservoir mounted on a stand connected to a solvent migrator for receiving a constant supply of solution thereto. A second reservoir is provided including a cloth to contact fluid in the secondary reservoir while being maintained parallel to the sun's rays with automatic leveling means and apparatus for water. The solar distiller is constructed in two parts consisting of a secondary reservoir and collecting dome of glass panels and collecting troughs running to the exterior of the unit with optional mirrors to capture and collect reflective light from the collecting dome.

U.S. Pat. No. 4,566,434 to Lindenbauer, hereby incorporated by reference in its entirety, sets forth a solar tracking energy collector to focus sun's rays at a desired orientation including a lens to focus the rays of the sun upon indentation of a collector which has a liquid conducting passageway fitted therearound for absorbing heat of the sun's rays and conducted to it by the lens.

U.S. Pat. No. 4,584,061 to Shelton, hereby incorporated by reference in its entirety, sets forth an apparatus including a spherical tank provided with means to introduce water to be converted to steam in a lower zone of the tank and structure to guide the steam into a condensate bowl within the same spherical tank.

U.S. Pat. No. 4,639,293 to Lew, hereby incorporated by reference in its entirety, sets forth a solar powered still wherein water to be distilled is supplied from a reservoir vessel sealed off after a batch loading wherein the vessel is elevated above a solar collector. Water is fed into a heater through an array of tubings through the solar collector with water directed by gravity through an orifice and heat exchanger condenser. The array of the heater tubing is routed through a solar collector is connected to another vertical tubing directed into an overflow tank.

U.S. Pat. No. 4,921,580 to Martes et al., hereby incorporated by reference in its entirety, discloses a solar water distiller is set forth utilizing a spherical boiler formed with an underlying concave reflective lens arranged for tracking of the position of the sun to effect boiling of water provided within the solar boiler. Water vapor is forcibly removed from the uppermost portion of the spherical boiler by a solar powered pump directing the cooling water into a condensate tank that is provided with a pressure relief valve. The spherical boiler is provided with a float level and a pressure gauge to control the actuation of a valve limiting water provided to the spherical boiler to maintain the spherical boiler with a half volume of fluid for maintaining efficiency of the boiler.

U.S. Pat. No. 7,658,071 to McDermott, hereby incorporated by reference in its entirety, discloses solar generators having Fresnel lenses and spaced heat absorbers or photovoltaic cells for receiving focused solar rays. Heat is removed from their backs by boiling liquid in conical receivers. Pins or fins extend rearward into the receivers from the heat absorbers or photovoltaic cells. Liquid supply to the receivers is controlled by valves and floats or sensors. Tubes remove steam or vapor from the receivers for driving generators or for cooling photovoltaic cells. Hinged tubes which form the foldable support conduct the steam to generators and condense the vapor. Liquid is returned to a holding tank, is pumped to a distribution tank and is conducted by some of the structural tubes back to the valved receivers.

U.S. Pat. No. 7,240,674 to Patterson, hereby incorporated by reference in its entirety, discloses a solar tracking apparatus which is movable from a morning position to an evening position, the apparatus comprising a support means to which a solar device can be supported, a cylinder, the cylinder including a ram which is extendable from and retractable into the cylinder, an expansion chamber which forms part of or which is in fluid connection with the cylinder, a liquid in the cylinder and the expansion chamber, the liquid having a boiling point which is greater than the maximum operating temperature of the cylinder and the expansion chamber, a return means to cause the apparatus to be returned to the morning position, and rotation means associated with the ram to rotate the apparatus from the morning position to the evening position upon extension of the ram.

U.S. Pat. No. 6,776,154 to Yogev, hereby incorporated by reference in its entirety, discloses a solar energy system comprises a solar absorber in the form of a solar boiler tank with a lower working liquid region having a liquid inlet and filled with a working liquid capable of boiling under a predetermined pressure, and an upper vapor accumulation region having a vapor outlet for withdrawing from the tank a vapor created in the tank. The system further comprises vapor utilization means associated with the vapor outlet. The solar boiler tank has at least one transparent window to receive and pass towards the working liquid highly concentrated solar radiation. The system also comprises means for controlling the pressure of vapor in the vapor accumulation region to make the working liquid boil at the predetermined pressure.

As can be appreciated, the use of solar energy for the heating of water is well known in the prior art. As may be also appreciated, however, these devices have lacked aspects to provide efficiency of operation and effectiveness, as particularly applied to small volume capacities as may be found wort production, especially residential wort production. While these apparatus are useful for their intended purposes they do not anticipate the benefits achieved when applying solar heating to wort production. However, aspects of these disclosures can be applied for the efficient use and application of the present invention by the knowledgeable brewer and user of solar power. Such aspects include, but are not limited to, the use of Fresnel lenses, tank designs, and solar tracking techniques and devices, including apparatus, mirrors and heliostats.

Any method of directing solar power can be used with the invention as described. This includes the simplest form of utilization of solar energy: placing the object to be heated in the path of photons of the sun's energy. More advanced methods of directing solar power are also conceived of including the use of mirror, lens and fiber optics. It is preferred that a lens is used to direct solar energy. It is especially preferred that a Fresnel lens is used to direct solar energy.

The solar energy can be utilized directly by directing sunlight onto a mash broth, this can be assisted with mirrors and lens. To assist the use of solar power the US Department of Commerce's National Oceanic & Atmospheric Administration (NOAA) provide to the public information for the angle of the sun at given times and dates. Such information is available in a variety of publications including a calculator of sun position available at the NOAA worldwide web site.

When applying the present invention to direct solar energy to a target container that contains a mash ready to be produced into a wort, the energy is most efficiently applied to the outside side surface of the container. The photons of solar energy strike the side of the container and are converted to heat energy which is conducted through the material of the container to the inside side surface and thereby conducted to the mash. The fluid of the mash is heated. Not wishing to be bound by theory, it is speculated through the theory of fluid dynamics that the warmer fluid of the mash rises within the container away from the source of heat and is replaced at that location by cooler mash mixture. This cycle continues until the mash mixture is heated and converted into wort by the applied solar power.

### Ovens for Conserving Heat

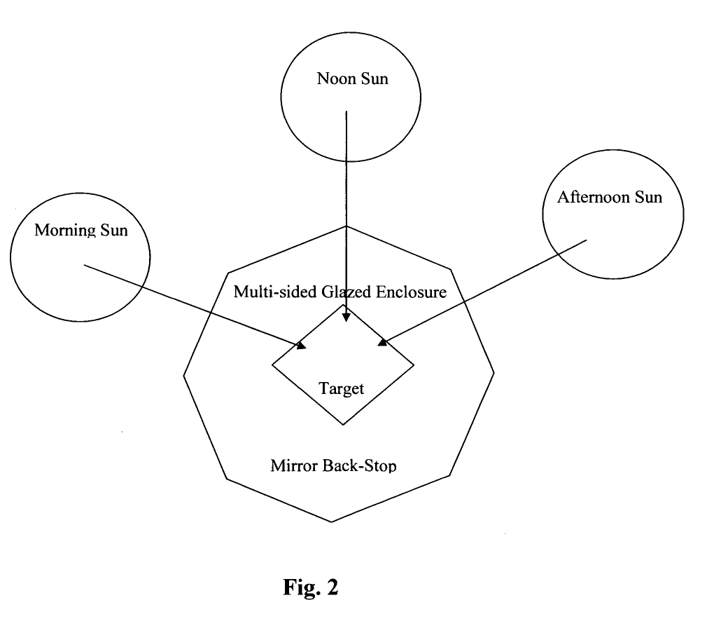

The glazed and sealed container works as an oven to keep the heat within confined area to keep heat losses minimal. Mirrors can be used inside to assist in focusing the beam and can be bounced in tight places where the sun does not usually shine. If solar tracking (heliostat) is not use, one must move the lens and target often (See FIG. 2). The Fresnel lens holding device must be able to tilt to the angle of the sun and move closer and further away from the targeted black vat as the azimuth, distance, focal length changes as the sun rolls around heavens all day.

It is helpful to use a high temperature metal vat painted flat matte black, kegging equipment with metal handles can be adapted for this purpose, for instance the Firestone and Cornelius tanks or Converted Sanke Kegs. Other materials that show promise include high-temperature food grade ceramics. It is suspected that he same design but made with Copper or Aluminum would transfer heat near 20 times better than stainless steel. Metal tanks with thermowell and pressure relief can make the wort boil at higher than normal temperatures, the effect of higher temperature and pressure is a shorter boiling time a vigorous boil not seen at ISA. Producing the wort under pressure creates an increase in the hop utilization that is not observed in the industry at standard atmospheric conditions. Hop utilization of greater than 30% have been observed, as have hop utilization of greater than 50%, greater than 75%, and greater than 90%. The IBU calculation of such beers is causally determined to be at factors much greater than the IBU calculation of a beer brewed at atmospheric condition.

### Speculation

It was unexpected that applying solar power to brewing would produce a distinctly different product than brewing using conventional methods. The inventor has considered why the invention has created a different product.

While not wishing to be bound by theory, it is recognized that in the roasting of hops is counter-intuitive to the conventional wisdom that fresh or unused hops should be stabilized at all times prior to use to preserve the hop oils and hops flavors. However, roast hops with solar power, or any means, destabilizes the hops. However, roasting may also seal the hops or created new combination of organic molecules that impart a different but desirable flavor or desirable quality to the products in which these solar roasted hops are an ingredient of.

While still not wishing to be bound by theory, it is especially noted that solar roasting of unused hops can create free-radials that could create different forms of molecules that have not or could not be achieved in hops handled in the conventional manners. Also the focused solar energy can reached temperature of upto and over 2000° F. (1093 C). At or close to these high temperature organic molecules may be produced that are novel to hops and impart a different but desirable flavor or desirable quality to the products in which these solar roasted hops are ingredient of.

While not wishing to be bound by theory the inventor also considered the solar roasted grains. Similarly to the solar produced free radicals that were discussed in the theory of solar roasted grains, the same solar produced free radicals could be active in the roasting process of solar roasted grains. Solar energy is known to create free radicals. Such free radicals when created in the midst of the complex organic molecules of starches, especially the complex organic molecules of malt barley, can combine the molecules in ways are that unique to brewing. It is believed that these solar produced free radicals may be the source of the novel properties of solar-roasted grains.

Without being bound by theory, considering the solar energy heated wort, the inventor has considered that the position of the heat source could account for the distinct flavor of the solar energy heated worts and the beverage created from them. Additionally, the high temperature of the heat applied to the outside surface of the container holding the mash could also contribute to the actions that produce the novel worts that are created from solar-energy heated worts. The inventor has observed that the temperature at the point of contact between the photons of solar energy and the side surface of the container holding the mash can reach to as high as 2000° F. (1093 C). It is believed that because the heat is applied to the side of the container and that the contents are liquid that the heat creates a unique rheology, wherein the currents created by the side source of heat bring organic molecules into contact with a high temperature so that these organic molecules can combine in ways that are novel and not previously observed in any other brewing process.

Decoction is an old style of producing wort from mash that boils parts of the mash and returns the subset to the total mash. Although not as easy to practice as infusion method or step (temperature-controlled) mash, decoction is still conducted because the method produces a unique style and flavor of beer.

Still not wishing to be bound by theory, heating the mash from the side of the container as is done in solar-energy produced wort may allow for unique combinations of organic molecules to occur as they do in the decoction method. However, decoction method is generally only practiced with two or three batches of boiling; whereas, the high temperatures in solar-energy wort production are applied continually during the wort-production process. These high temperatures can produce a variety of organic molecules, these organic molecules could be the factor that imparts a unique flavor to solar-energy heated wort. The unique organic molecules can be produced through the process of caramelization, or through interaction of the starches and sugars with amino acids in a Maillard reaction, such organic molecules include melanoidins (anti-oxidants). It is also believe that the high temperature and unique currents produced by solar powered heating may lead to the development of additional anti-oxidants in the wort, further contributing to its unique properties.

In an effort to find an energy efficient method of producing a wort, the inventor created a different approach to wort heating. In doing so the wort, has been heated from the side. This novel position in heating creates a novel wort that is discernable in the fermentation product that produced from the wort. The inventor was also concerned with efficiently, by placing the wort in a glazed system to prevent radiation heat loss, the temperatures at the inside surface of the point of contact on the side surface of the vat were allowed to escalate much beyond common temperatures at the point of contact on a stove top or other heating system. Such high temperatures on the side inside surface of the vat are novel. The wort produced by the solar heating methods described herein are novel.

### EXAMPLES

The examples presented herein are not intended to be limiting. Knowledge practitioners should be able to further ascertain the invention and its usefulness by reading the follow examples.

### Example 1

Heretofore, the brewer produces a different hopped wort stream for each finished beer product, having the desired kettle hop flavor characteristics. This entails using dedicated equipment for each such wort stream. Thus, the brewer is faced with many production, quality control, and financial considerations especially when many different products must be produced.

Fermentation used to produce beer as described herein can be further enhanced by the use of additional ingredients. This is well known in the art. However, introduced by this process is an ingredient novel in the art of beer making: toasted hops, preferably solar toasted hops. An example of the use of solar toasted hops is described as follows:

### (2) 3# Briess Pilsen Light DME;

1# Solar toasted Munton's Crystal 60 L;
2 oz Solar toasted Hey Pilgrims Hops (11%) Bitter;
2 oz Solar toasted Hey Pilgrims Hops (11%) Knock-off;
2 oz Solar toasted Hey Pilgrims Hops (11%) Hop Back; and

### 1 White Labs East Coast Ale.

This produces a beer with the following characteristics:

### OG 1.050@80 F;

### FG: 1.006@66 F; and

### ABV: 5.78%.

### Grain/Hop/Herb/Spice/Adjuncts Solar Toasting With Fresnel Lens:

The Fresnel lens is a great way to solar toast barley grains, any grain (i.e. including but not limited to barley oats, wheat, rye, and similar grains also flaked, torrified, whole beech, peat smoking similar styles can be toasted). The smell of roasted grains is aroma therapy, but even more appealing is the smell of toasted Hops. If a method of turning the grains and hops is used, a more uniform heating is attained, but burning the grains is not considered detrimental to the beer if uniform turning is not performed. It will add color and body like the uniform hot air kilned malts that are commercially available, but with fresher flavors.

### Example 2

### Materials

1 Fresnel lens (spot Fresnel lens is acceptable, linear Fresnel Lens is preferred) 1 square meter is roughly 1200 watts (1200 watts is over 1 BTU/sec.). The clearer Fresnel lens, the better, the larger space inbetween the circles, the more light gets through and the hotter the lens. Fresnel lens can be readily obtained from recycled projection TV's. The larger lens the more BTU's available for directing solar photon to the target. This lens has to be securely mounted, but tiltable and movable.

2 A high temperature metal Vat (vessel) painted flat Matt black. Suitable examples include kegging equipment the Firestone and Cornelius tanks or Converted Sanke Kegs with metal handles (Caution: equipment with rubber handles will melt due to the heat), high-temperature food grade ceramics are also suitable, as are other suitable vat well-known in the field. The same design but made with Copper or Aluminum would transfer heat near 20 times better than stainless. (Note: Metal tanks with thermowell and pressure relief can make the wort boil at higher than normal temperatures, the effect of higher temperature and pressure is a shorter boiling time an extreme violent and rigorous boil not seen at ISA. The cold break will be much greater. The wort and an increase in the hop utilization that is presently observed to be greater than 90%.

3 Temperature monitoring equipment with remote readout capability is an advantage as you do not want to open and measure temperature due to heat loss, and necessary for those who import precise records keeping.

4 Some “oven” type of glazed and sealed with lid or door. Glass door refrigerators and freezers work fine and can be obtained readily.

5 Eye protection is required when working with solar rays, especially those rays directed by mirrors and lens. Sunglasses are acceptable; a welder's mask is preferred.

6 Mirrors for light reflecting for remote applications where the sun is needed to be redirected to the Fresnel lens.

7 Pre-heated water from any solar hot water maker is very useful in reducing the delta between the start and target temperature.

8 High Temperature Gloves, the Fresnel lens can produce temperature above 1000 C. For safety, the Fresnel lens ought to be treated like a lit industrial welding torch.

9 Immersion, counter flow or plate wort chiller.

10 A heliostat that can move the Fresnel and target either automatically or manually and the elevations and focal point placement is paramount.

### Procedure (All-Grain):

The following description of one process of making 5 gallons (40 L) of Solar All-Grain fermentation with the above equipment.

1. Collecting solar hot water, the warmer it is to start with, the quicker it will be heated. For the purpose of illustration 450′ ⅝″ I.D. Flat Black High Temperature Hose with 7.2 gal US Volume (Capacity). Most passive solar water heaters will be acceptable for use. The heat exchanger is also used as a heating device to hold the mash at the ˜150 F temperature as it recharges for the sparge water. The hoses can be looped with Y-connectors to keep the pressure and circulation going and thus avoiding any electrical assistance, but if some is needed, electrical solar cells can power a small high temperature pump. A Fresnel lens can also be used on a flat Black Vat to heat the water.

2. The mash can be heated with the Fresnel lens in a decoction like manner, raising the temperature in increments or in a linear manner.

3. Mash till conversion is complete (iodine starch test) and sparge with recharged solar heated water through the heat exchanger. Collect 6 gallon runoff in Flat Matt Black High Temperature Vat, first wort hopping as well as the bittering hops can be added here. (Note: A Spot Fresnel lens can generate 2,700 F in a ¼″-½″ area and a linear Fresnel Lens will heat more evenly at about 700 F in a ½″×4″-6″ area and is preferred.

4. It is advisable to either most of the kettle additions (Hops and Irish Moss) in before the Fresnel lens is focused upon the vat, this is because opening it up would lose BTUs.

5. There are two methods of heating, one the open method with the Fresnel focused directly on the matt black vat, a faster way of retaining the heat is to use an “oven” with glazing and insulation. For the most part, any glass door refrigerator will work if it can fit the vat in it. Care should be taken to assure the insides will not melt or give of noxious fumes if the Fresnel beam misses the vat due to alignment with the sun. A temperature gauge that is big enough to be readable inside or remotely read will be necessary. A pressure gauge would also be useful. The boiling wort will need to be vented to avoid DMS (sweet corn taste).

6. When the wort is boiled for an hour cover the Fresnel lens and remove it with High Temperature Gloves from the oven, if used. Handle and open carefully as it a vat of near boiling wort, and high pressured steam may be involved.

7. Cool the wort using a wort chiller, using the byproduct as hot water to wash, clean and sanitize the mash tun and the primary fermentor. Rack, gravity feed or solar pump the wort to the primary fermentor, When at pitching temperature, take gravity reading, aerate and pitch the yeast, aerate again, seal with airlock, ferment.

### Example 3

### Procedure (Extract/Specialty Grains)

The following is a rough description of the process of making 5 gallons of solar extract or extract w/specialty grains homebrew with the above equipment.

1 Collecting solar hot water, the warmer it is to start with, the quicker it will be heated. For the purpose of illustration: 250′ ⅝″ I.D. Flat Black High Temperature Hose with 4 gallon U.S. Volume (Capacity). Most passive solar water heaters (i.e., Black hose, solar hot water . . . ) will be acceptable for use. The heat exchanger is also used as a heating device to hold the mash at the ˜150 F temperature as it recharges for the sparge water. The hoses can be looped with Y-connectors to keep the pressure and circulation going and also to bleed the system of air.

2. If extract/specialty grains are used, steep grains ˜150 F for 20 minutes, sparge and remove. Thoroughly mix in LME or DME, add bittering hops. It is advisable to either most of the kettle additions (Hops and Irish Moss) in before the Fresnel lens is focused upon the vat, this is because opening it up would lose BTUs and the risk of DMS from a short or non-vigorous boil.

3. There are two methods of heating, one the open method with the Fresnel focused directly on the matt black vat, a faster way of retaining the heat is to use an “oven” with glazing and insulation. For the most part, any glass door refrigerator will work if it can fit the vat in it. Care should be taken to assure the insides will not melt or give of noxious fumes if the Fresnel beam misses the vat due to alignment with the sun. A temperature gauge that is big enough to be readable inside or remotely read will be necessary. A pressure gauge would also be useful. The boiling wort will need to be vented to avoid DMS (sweet corn taste).

4. When the wort is boiled for an hour cover the Fresnel lens and remove it with High Temperature Gloves from the “oven” if used. Handle and open carefully as it a vat of near boiling wort, and high pressured steam may be involved.

5. Cool the wort using a wort chiller, using the byproduct as hot water to wash, clean and sanitize the mash tun and the primary fermentor. Rack, gravity feed or solar pump the wort to the primary fermentor, When at pitching temperature, take gravity reading, aerate and pitch the yeast, aerate again, seal with airlock, ferment.

### Example 4

### Solar Brewed Ballantine IPA

### Original Gravity: 1.050

### Final Gravity: 1.012

### Ingredients and Directions

### Specialty Malts:

### 8# Briess 2-Row Brewer's Malt

### 2# Solar-Toasted Briess 2-Row Brewers Malt

### 1# Briess 60 L Crystal

½# Briess Carapils

### Hops:

2 oz. Brewers Gold Bittering Hops
1 oz. Brewers Gold Knock-It-Off Hops

### Yeast:

1 ECY10 Old Newark Ale (from East Coast Yeast)

### Steps to Solar Homebrew Beer:

Under appropriate atmospheric conditions, prepare both Spot and Linear Fresnel lens, wheel assembly for positioning the lens, and an oven (in this example a repurposed convenience store fridge. Wear eye protection. Always use caution: the Fresnel lens can heat to above 1000 C.

Heat the 4 gallons of strike water to 135 F with the Fresnel Lens pointed at the side of a 20# water filled Aluminum CO2 tank painted high temperature flat black (capacity ˜4 gallons, called the “Hot Liquor Tank” or “Pressurized Brew Tank” depending on which stage it is used).

Solar Toast 2# Pale malt to a color around 20 L-50 L, ˜till it looks like toasted Malt, be careful and stir the grains—or it will they turn black, absorb more heat and may catch on fire.

Mill all the grains.

Simultaneously, while mashing, heat sparge water to 170 F in Hot Liquor tank with a Fresnel lens.

Mash the grains in a 10 gal. Corny tank painted Flat Black (hence called the “mash tun”) The mash tun has a ½″ SS bazooka screen fastened on the dip tube with a ½″×¼″ holed spacers for rigidity and secured with an adjustable ring clamp, which serves as the false bottom. The dip tube is cut ¾″ off the bottom. Once mashed-in, add several more inches of strike water on top of the mash, cover the mash tun and aim the Fresnel Lens so that the concentrated sun light is hitting the mash tun where the mash is, (not above it.) The high temperature flat black paint will absorb the concentrated solar radiation. The mash tun and fresnel lens must be moved every 15 minutes so the sun/fresnel lens/target plane is almost perfectly aligned˜which about roughly 30 inches away, or where the beam is focused, also, check the shadows for alignment. In this area the mash will boil and create Melanoidin's (anti-oxidants) through the Maillard reaction. This heat will slowly radiate throughout the mash till it rises to 148 F-158 F, seal and hold in the oven for at least ½ hour without the fresnel lens, perform a starch test with iodine.

Add all the 170 F sparge water that was heating in the other hot liquor tank to mash tun.

Seal the mash tun and push the wort out of the Corny with a pressure no greater than 4 psi (1.25 atm). The low pressure will push the runnings into the two Pressurized Brew Tanks. Add the bittering hops in muslin bag and seal with both tanks with CO2 Aluminum Cylinder Valve (3000 psi (1093 atm) heat both Pressurized Brew tanks with the Fresnel Lens at the and SuperBoil under pressure for 30 minutes, carefully vent at 30 minutes to release volatiles, seal, and put in the oven for one hour with the Fresnel lens searingly pointed at the Pressurized Brew Tank. Open and add 1 oz. Brewer's Gold knock-it-off hops.

Chill both 20# Aluminum CO₂ tanks down to pitching temperature.

Transfer to two 5 gallons Corny tanks, pitch yeast, also for formation per standard industry procedures.

1. (canceled)

2. A method of making a wort from a mash in a container, wherein
the container has an outside and an inside, the container also has at least one side surface, a bottom surface, optionally a top surface;
wherein, the mash has been assembled inside the container and comprises water and at least one complex sugar or at least one starch; and
wherein, energy is directed to the outside side surface of the container producing heat that is conducted through the material of the container to the mash therein such that energy is directed to the outside side surface of the container is substantially the source of heat of the wort making wherein the energy is directed to the outside side surface of the container is photons of solar energy, and wherein a Fresnel lens is used to direct the photons of solar energy to the container, and wherein the container is made of a metal.

3. (canceled)

4. (canceled)

5. (canceled)

6. (canceled)

7. (canceled)

8. The method of claim 2, wherein the container is contained within a system containing glazing that permits photons of light energy to enter the system and to reach the point of contact while insulating the system from loss of heat energy.

9. The method of claim 2, wherein the sugar or the starch is selected from a group consisting of: barley, malted barley, wheat, corn, rye, rice, spelt, millet, milo maize, oats, buckwheat, sorghum, quinoa, honey, tapioca, cassava, manioc, triticale, tef, dinkel, amaranth and combinations thereof.

10. (canceled)

11. (canceled)

12. The method of claim 2, wherein the container is pressurized to greater than about 34 atm.

13. (canceled)

14. (canceled)

15. (canceled)

16. (canceled)

17. The method of claim 2, wherein, roasted hops are added to the mash during the production of the wort.

18. The method of claim 2 wherein, the method is a step within a system for brewing a beverage substantially using solar power as a power course comprising the following steps:
a. using solar power to roast grains selected from the group consisting of the following: barley, malted barley, corn, wheat, oats, rye spelt and combinations thereof; wherein photons of solar energy are directed through a lens onto said grains in sufficient amount and duration to roast said grains;
b. optionally, using solar power to roast hops, wherein photon of solar energy are directed through a lens on said hops in sufficient amount and duration to roast;
c. combining a mash for making a wort, comprising water and the solar roasted grains, from step (b);
d. making a wort using the method of claim 2;
e. optionally, adding solar roasted hops during the making of the wort;
f. bringing the wort to a boil during the making of the wort;
g. optionally, adding solar roasted hops during the boiling of the wort;
h. cooling the boiled wort of step (g) to a temperature at which a yeast can survive;
i. optionally, adding solar roasted hops during the cooling of the wort;
j. optionally, adding yeast to the wort of step (h) and allowing the yeast of step (h) to ferment the wort of step (h).

19. The wort produced from the method of claim 2.

20. The beverage produced from the method of claim 18.

21. A method roasting grains, wherein a lens is used to direct photons of solar energy onto grains selected from the group consisting of: barley, malted barley, corn, wheat, oats, rye spelt and combinations thereof, for a period of time sufficient to cause roasting; and wherein the heat from the solar energy is substantially the source heat for the roasting.

22. The method of claim 21 wherein, a Fresnel lens is used to direct the photons of solar energy onto the grains.

23. The method of claim 22 wherein the grain is barley.

24. The method of claim 22, wherein the grain is wheat.

25. The method of claim 22, where the grain has been malted prior to the roasting.

26. The method of claim 22, wherein the grains are rotated during the roasting process.

27. The method of claim 22 wherein, the method is a step within a system for brewing a beverage substantially using solar power as a power course comprising the following steps:
a. roasting grains according to the method of claim 22;
b. optionally, using solar power to roast hops, wherein photon of solar energy are directed through a lens on said hops in sufficient amount and duration to roast;
c. combining a mash for making a wort, comprising water and the solar roasted grains, from step (a);
d. making a wort from a mash of step (c) in a metal container, wherein the container has an outside and an inside, the container also has at least one side surface, a bottom surface, optionally a top surface; wherein, the mash has been assembled inside the container; and wherein, photons of solar energy are directed to the outside side surface of the container using a Fresnel lens to produce heat that is conducted through the material of the container to the mash therein such that energy is directed to the outside side surface of the container is substantially the source of heat of the wort making;
e. optionally, adding solar roasted hops during the making of the wort;
f. using solar energy directed through a Fresnel lens to bring the wort to a boil during the making of the wort;
g. optionally, adding solar roasted hops during the boiling of the wort;
h. cooling the wort that was boiled during (f) to a temperature at which a yeast can survive;
i. optionally, adding solar roasted hops during the cooling of the wort;
j. optionally, adding yeast to the wort of step (h) and allowing the yeast of step (h) to ferment the wort of step (h).

28. The roasted grains produced from the method of claim 22.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. A kit for conducting fermentation, wherein the kit includes:
a. A lens; and
b. Instructions for use of the lens for directing solar energy in the process of wort making involving the following steps
1. using a lens to direct photons of energy to a container containing a mash, wherein the container has at least one side surface, a bottom surface, and optionally a top surface, the container also having an outside and an inside;
2. directing the photons of energy to the outside side surface of the container;
3. using the solar energy to substantially provide the heat involved in producing the wort.

42. The kit of claim 41, wherein the lens is a Fresnel lens.

43. (canceled)

44. The kit of claim 41, wherein grains are provided.

45. (canceled)

46. The kit of claim 41, wherein the instructions include directions for using a lens with a system containing glazing that permits photons of light energy to enter the system while insulating the system from loss of heat energy.
